(19) United States
(12) Patent Application Publication
(10) Pub. No.: US 2026/0181598 A1
(43) Pub. Date: Jun. 25, 2026

(54) METHODS, ARCHITECTURES, APPARATUSES, AND SYSTEMS FOR IMPLICIT INDICATION OF BASE STATION-BASED SENSING

(71) Applicant: InterDigital Patent Holdings, Inc., Wilmington, DE (US)

(72) Inventors: Fumihiro Hasegawa, Westmount (CA); Moon IL Lee, Melville, NY (US); Arman Shojaeifard, London (GB); Jongwoo Hong, New York, NY (US); Remun Koirala, London (GB); Paul Marinier, Brossard (CA); Ghyslain Pelletier, Montreal (CA)

(21) Appl. No.: 18/991,149

(22) Filed: Dec. 20, 2024

(51) Int. Cl. H04W 72/044; G01S 7/00; G01S 13/86

(52) U.S. Cl. CPC H04W 72/044; G01S 7/006; G01S 13/86

(57) ABSTRACT

Procedures, methods, architectures, apparatuses, systems, devices, and computer program products are provided for a wireless transmit/receive unit (WTRU) to perform base station-based sensing in communication with a wireless network. A method includes receiving configuration information from the network, monitoring for an indication signal at a specified periodicity, and determining a monitoring periodicity for a sensing signal upon detecting the indication signal. The WTRU performs measurements of the sensing signal and reports the results to the network. The method supports both monostatic and bistatic sensing, and includes provisions for handling synchronization signal blocks (SSB) and adjusting search periodicity based on the WTRU's location. Additionally, the WTRU can cancel or postpone uplink transmissions that conflict with sensing resources. Further, the network role transmits configuration information and requests for report measurements, which results in the WTRU monitoring and reporting the sensing signal measurements.

### TECHNICAL FIELD

The present disclosure is generally directed to the fields of communications, hardware, software and encoding, including, for example, to methods, architectures, apparatuses, and systems related to sensing in wireless networks, including implicit indication of base station-based sensing.

### BACKGROUND

Functional specifications are provided for User Equipment (UE) positioning in the Next Generation Radio Access Network (NG-RAN). The specifications include descriptions of various positioning methods, including network-assisted Global Navigation Satellite System (GNSS), Observed Time Difference of Arrival (OTDOA), Enhanced Cell ID (E-CID), a barometric pressure sensor, Wireless Local Area Network (WLAN), Bluetooth, Terrestrial Beacon Systems (TBS), a motion sensor, New Radio (NR) Enhanced Cell Identifier (ID), Multi-Round Trip Time (RTT), Downlink Angle-of-Departure (DL-AoD), Downlink Time Difference of Arrival (DL-TDOA), Uplink Time Difference of Arrival (UL-TDOA), Uplink Angle-of-Arrival (UL-AoA), and sidelink (SL) positioning and ranging. The specifications include descriptions of an NG-RAN UE positioning architecture, including the roles and operations of elements like UE, Next Generation Node B (gNB), Next Generation Evolved Node B (ng-eNB), Location Management Function (LMF), and Positioning Reference Unit (PRU). Signaling protocols and interfaces used for positioning are described. The specifications include general positioning procedures, including Long-Term Evolution Positioning Protocol (LPP) and NR Positioning Protocol A (NRPPa), service layer support, and specific operations like On-Demand Positioning Reference Signal (PRS) configurations, preconfigured measurement gaps, and PRS processing windows. However, numerous technical challenges remain.

### SUMMARY

In certain representative embodiments, a method is performed by a wireless transmit/receive unit (WTRU) in communication with a wireless network. For example, the method includes at least one of: receiving, from the wireless network, configuration information indicating time-frequency resources for base station-based sensing; monitoring for an indication signal for the base station-based sensing, wherein the monitoring is performed at a search periodicity in the time-frequency resources; after detecting the indication signal, determining a monitoring periodicity associated with a sensing signal for the base station-based sensing; performing one or more measurements of the sensing signal in the time-frequency resources based on the monitoring periodicity; or transmitting, to the network, a report indicating results of the one or more measurements.

In certain representative embodiments, a wireless transmit/receive unit (WTRU) is provided in communication with a wireless network. For example, the WTRU includes a processor; and a transceiver coupled to the processor. Also, for example, the WTRU is configured to perform at least one of: receive, from the wireless network, configuration information indicating time-frequency resources for base station-based sensing; monitor for an indication signal at a search periodicity in the time-frequency resources; after detecting the indication signal, determine a monitoring periodicity associated with a sensing signal for the base station-based sensing; perform one or more measurements of the sensing signal in the time-frequency resources based on the monitoring periodicity; or transmit, to the network, a report indicating results of the one or more measurements.

In certain representative embodiments, a method is performed by a wireless network in communication with a wireless transmit/receive unit (WTRU). For example, the method includes at least one of: transmitting, to the WTRU, configuration information indicating time-frequency resources for base station-based sensing; transmitting, to the WTRU, a request indicating one or more report measurements; causing the WTRU to monitor for an indication signal at a search periodicity in the time-frequency resources; causing the WTRU to after detecting the indication signal, determine a monitoring periodicity associated with a sensing signal for the base station-based sensing; causing the WTRU to perform one or more measurements of the sensing signal in the time-frequency resources based on the monitoring periodicity; causing the WTRU to transmit, to the network, a report indicating the one or more measurements; or receiving, from the WTRU, the report indicating results of the one or more report measurements.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit and/or receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating examples of parameters for a measurement gap, in accordance with some embodiments of this disclosure;

FIG. 3A is a diagram illustrating an example of base station (e.g., gNB)-monostatic sensing, in accordance with some embodiments of this disclosure;

FIG. 3B is a diagram illustrating an example of bistatic sensing, in accordance with some embodiments of this disclosure;

FIG. 4 is a diagram illustrating an example of transmissions for sensing measured by WTRUs, in accordance with some embodiments of this disclosure;

FIG. 5 is a chart illustrating an example of a Synchronization Signal Block (SSB) indicating presence of a sensing Reference Signal (RS), in accordance with some embodiments of this disclosure;

FIG. 6 is a chart illustrating an example of no SSB, which means sensing RS is not present, in accordance with some embodiments of this disclosure;

FIG. 7 is a sequence diagram illustrating an example sequence of a procedure for signal exchange between a WTRU and a base station (e.g., gNB), in accordance with some embodiments of this disclosure;

FIG. 8 is a procedural diagram illustrating an example procedure for a WTRU in communication with a wireless network performing base station-based sensing, in accordance with some embodiments of this disclosure; and

FIG. 9 is a procedural diagram illustrating an example procedure for a wireless network performing base station-based sensing, in accordance with some embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

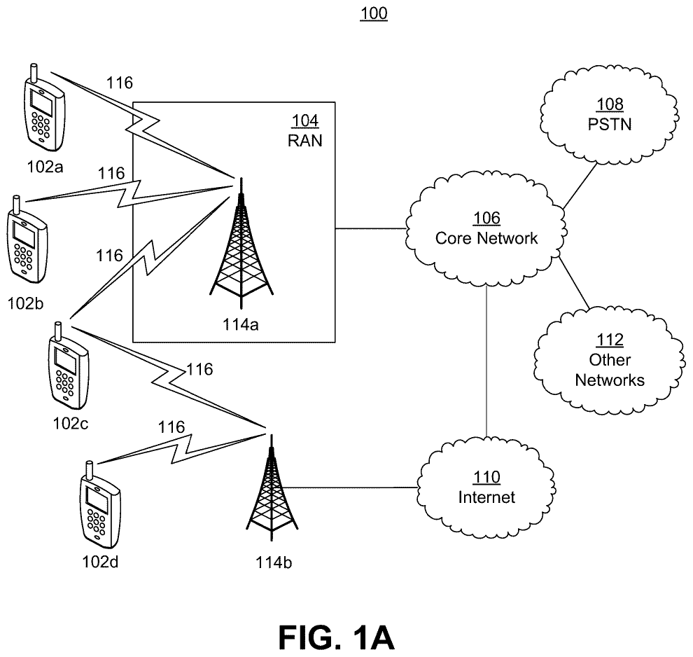

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit and/or receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable radio access technology (RAT) for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite.

The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities.

Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-ID, and the corresponding description of FIGS. 1A-ID, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In certain representative embodiments, methods and systems are provided for implicit indication of base station (e.g., gNB)-based sensing. For example, the implicit indication of base station (e.g., gNB)-based sensing is provided, e.g., for Integrated Sensing and Communication (ISAC). Also, for example, measurement behavior is provided. Further, for example, measurement reporting is provided. In addition, for example, a WTRU receives one or more configurations for a time-frequency resource where sensing signals are transmitted. It is noted, throughout the present specification, where “time-frequency” is used, it is understood to mean time and/or frequency.

Moreover, for example, the WTRU receives a request to make one or more measurements on sensing signals. Furthermore, for example, if the WTRU detects the presence of the sensing signals, the WTRU reports the one or more measurements to a wireless network.

In certain representative embodiments, either alone or in combination with one or more features of the methods and systems disclosed herein, a gNB may perform monostatic sensing or bistatic sensing. The gNB may not have time to inform the WTRUs about details of gNB-based sensing operation (e.g., intruder detection). Each time the gNB adjusts its transmission parameters, signal exchange needs to happen between WTRU and gNB, causing latency in sensing operations.

The gNB may perform both sensing and communication operation. Thus, the WTRU may need to perform communication related tasks (e.g., measuring SSBs and DL-RS, or the like) while gNB sensing is taking place.

In certain representative embodiments, either alone or in combination with one or more features of the methods and systems disclosed herein, a WTRU may send a request to the network for configuration (e.g., DL-RS configurations, UL-RS configurations, or the like), e.g., in at least one of Physical Uplink Shared Channel (PUSCH), Physical Uplink Control Channel (PUCCH), Uplink Control Information (UCI), Medium Access Control-Control Element (MAC-CE), Radio Resource Control (RRC), LTE Positioning Protocol (LPP) message, combinations of the same, or the like. For example, the request from the WTRU may include configurations of a measurement gap, a DL-RS processing window, a window for transmission of UL-RS, or the like.

The WTRU may send an acknowledgement message in PUSCH or PUCCH for a grant received from the network.

Two or more conditions and/or criteria can be used in a combination. The WTRU may be configured with two or more conditions and associated WTRU behavior. The WTRU may determine which behavior the WTRU shall use based on the applicable condition.

The WTRU can measure a DL-RS inside or outside of an active bandwidth part (BWP).

The WTRU may transmit a UL-RS inside or outside of an active BWP.

The WTRU may be preconfigured with parameters (e.g., measurement gaps, DL-RS processing windows, DL-RS configurations, UL-RS configurations, or the like) via a semi-static message (e.g., LPP, RRC, or the like).

Any actions the WTRU determines to take may be configured by the network. For example, the WTRU may be configured with a rule and according to the rule, the WTRU may determine to take an associated action.

In addition to the measurements made on DL-RS, the WTRU may include at least one of the following cell-related measurements: SSB Reference Signal Received Power (RSRP) from the serving cell with corresponding cell ID, SSB RSRP from the one or more neighboring cells with one or more corresponding cell IDs, RSRP of Channel State Information Reference Signal (CSI-RS) with CSI-RS resource ID, RSRP of Demodulation Reference Signal (DM-RS), combinations of the same, or the like.

Throughout the present disclosure, the following terminology may be used. The following definitions generally apply unless noted otherwise or implied otherwise by context.

In this disclosure, “Network” may include AMF, LMF, gNB, NG-RAN, or the like.

“Pre-configuration” and “configuration” may be used interchangeably in this disclosure.

“Non-serving gNB” and “neighboring gNB” may be used interchangeably in this disclosure.

The terms “gNB” and Transmission Reception Point (“TRP”) may be used interchangeably in this disclosure.

“DL-RS” or “DL-RS resource” may be used interchangeably in this disclosure.

“DL-RS(s)” or “DL-RS resource(s)” may be used interchangeably in this disclosure. The aforementioned “DL-RS(s)” or “DL-RS resource(s)” may belong to different DL-RS resource sets.

“Measurement gap” or “measurement gap pattern” may be used interchangeably in this disclosure. “Measurement gap pattern” may include parameters such as measurement gap duration or measurement gap repetition period or measurement gap periodicity.

An LMF is a non-limiting example of a node or entity (e.g., network node or entity, or the like) that may be used for or to support positioning or sensing. Any other node or entity may be substituted for LMF and still be consistent with this disclosure.

The WTRU may receive one or more preconfigured thresholds from the network (e.g., LMF, gNB, or the like).

A Line of Sight (LoS) indicator may be a hard indicator (e.g., 1 or 0) or a soft indicator (e.g., 0, 0.1, 0.2, . . . , 1). The LoS indicator may indicate a likelihood of the presence of an LoS path between a TRP and a WTRU or along DL-RS. The LoS indicator can be associated with a TRP or PRS resource ID (e.g., index). The WTRU may receive the LoS indicator from the network per TRP or resource ID. Alternatively, the WTRU may determine the LoS indicator per TRP or resource ID based on measurements.

In the examples described herein, “ID” and “index” may be used interchangeably.

A WTRU location may be expressed in terms of altitude, latitude, geographic coordinate, local coordinate, or the like, for example.

In the examples described herein, a timestamp may be indicated by absolute time, relative time (e.g., in seconds) compared to a reference time, System Frame Number (SFN), slot index, frame index, subframe index and/or symbol index, or the like. Examples of “absolute time” may be Coordinate Universal Time (UTC) time, Global Navigation Satellite System (GNSS) time, locally defined absolute time (e.g., LTE Time, NR Time, or the like), or the like.

In the examples described herein, the WTRU may receive configurations for a time window such as duration (e.g., expressed in terms of seconds, number of symbols, number of slots, number of frames, number of subframes, or the like), start and/or end time (e.g., expressed in terms of absolute time, system time, relative time with respect to a reference time indicated by the network or determined by the WTRU, SNF index, slot index, symbol index, frame index, subframe index, or the like), or the like. The WTRU may receive two or more configurations of a time window where each configuration is associated with an index. The time window can be initiated with a trigger sent by the network. For example, the WTRU may receive a command (e.g., Downlink Control Information (DCI)) to initiate an indicated time window, indicated via the configuration index. The WTRU may determine to initiate the time window after a configured duration after reception of the command (e.g., N symbols, N slots, N frames, N seconds, or the like). The WTRU may receive an activation or deactivation command (e.g., DCI, MAC-CE, or the like) to activate or deactivate the time window, respectively, from the network.

In certain representative embodiments, either alone or in combination with one or more features of the methods and systems disclosed herein, one or more configurations for one or more RSs are provided. For example, the one or more configurations for the one or more RSs include at least one of one or more configurations for DL-RS, one or more configurations for UL-RS, a measurement gap, a prioritization window, one or more positioning techniques, one or more channel impulse responses (CIRs), one or more associations to one or more RS configurations, combinations of the same, or the like.

In one example, the WTRU may receive DL-RS and/or UL-RS (e.g., Sounding Reference Signal (SRS)) configurations for positioning purpose from the network (e.g., LMF). The LMF may forward the PRS configuration and SRS configurations to the gNB so that the gNB can schedule PRS transmission or SRS reception at the TRP, Transmission Point (TP) and/or Reception Point (RP).

For example, configurations for DL-RS are provided. In one example, a DL-RS configuration may contain at least one of the following parameters: number of symbols, transmission power, number of DL-RS resources included in DL-RS resource set, muting pattern for DL-RS (for example, the muting pattern may be expressed via a bitmap, or the like), periodicity, type of DL-RS (e.g., periodic, semi-persistent, or aperiodic, or the like), slot offset for periodic transmission for DL-RS, vertical shift of DL-RS pattern in the frequency domain, time gap during repetition, repetition factor, resource element (RE) offset, comb pattern, comb size, spatial relation (e.g., with respect to other DL-RSs or UL RS such as SRS for positioning purpose, or the like), Quasi Co-Location (QCL) information (e.g., QCL target, QCL source, or the like) for DL-RS, number of TRPs, Absolute Radio-Frequency Channel Number (ARFCN), subcarrier spacing, expected Reference Signal Time Difference (RSTD), uncertainty in expected RSTD, start Physical Resource Block (PRB), bandwidth, BWP ID, number of frequency layers, start and/or end time for DL-RS transmission, on and/or off indicator for DL-RS, TRP ID, DL-RS ID, cell ID, global cell ID and applicable time window, or the like. The WTRU may apply a DL-RS configuration under a condition that the current time is within the applicable time window. “ID” may be used interchangeably with “index”. Examples of DL-RS include CSI-RS, Phase Tracking Reference Signal (PTRS), PRS, TRS, SSB, or the like.

For example, configurations for UL-RS are provided. In one example, UL-RS or SRS configuration may include at least one of: resource ID; comb offset values, cyclic shift values; start position in the frequency domain; number of UL-RS symbols; shift in the frequency domain for UL-RS; frequency hopping pattern; type of UL-RS (e.g., aperiodic, semi-persistent, periodic, or the like); sequence ID used to generate UL-RS, or other IDs used to generate UL-RS sequence; spatial relation information, indicating which reference signal (e.g., DL RS, UL RS, CSI-RS, SRS, DM-RS, or the like) or SSB (e.g., SSB ID, cell ID of the SSB, or the like) the UL-RS is related to spatially where the UL-RS and DL RS may be aligned spatially; QCL information (e.g., a QCL relationship between UL-RS and other reference signals or SSB, or the like); QCL type (e.g., QCL type A, QCL type B, QCL type C, QCL type D, or the like); resource set ID; list of UL-RS resources in the resource set; transmission power related information; pathloss reference information which may contain index for SSB, CSI-RS or DL-RS; periodicity of UL-RS transmission; bandwidth (e.g., in terms of resource blocks, MHz, or the like); carrier frequency; center frequency; and/or spatial information such as spatial direction information of UL-RS transmission (e.g., beam information, angles of transmission, or the like), spatial direction information of DL RS reception (e.g., beam ID used to receive DL RS, angle of arrival, or the like); combinations of the same; or the like. Again, it is noted, “ID” may be used interchangeably with “index”. Examples of UL-RS include SRS, and SRS for positioning purpose, or the like.

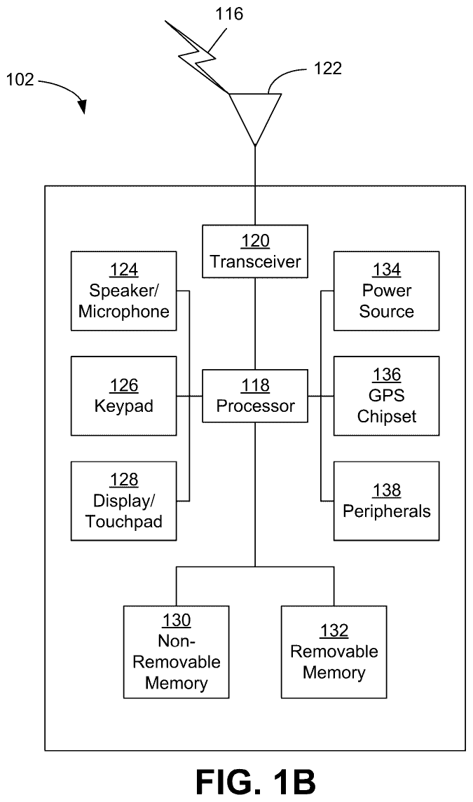

For example, a measurement gap or prioritization window is provided. Also, for example, the WTRU is configured to receive DL-RS during a DL-RS processing window or measurement gap. The measurement gap or DL-RS processing window may be configured by the network (e.g., LMF, gNB, or the like). Examples of the parameters of a measurement gap or DL-RS processing window are shown in FIG. 2. Similar parameters may be defined for a DL-RS processing window. During the measurement gap, indicated by “measurement gap length” in FIG. 2, the WTRU may receive an indication and/or configuration to make measurements on DL-RS during the gap length and process the measurements. Each measurement gap pattern or DL-RS processing window pattern may be characterized by a set of gap length, gap periodicity, and/or offset, or the like. A priority level may be associated with a DL-RS prioritization window. The WTRU may receive a message from the network (e.g., gNB, LMF, or the like) indicating the priority level of the PRS prioritization window.

For example, either alone or in combination with one or more features of the methods and systems disclosed herein, positioning techniques are provided. In 3GPP, the following categories of WTRU positioning techniques are specified. A “DL positioning method” may refer to any positioning method that uses downlink reference signals such as PRS. The WTRU receives multiple reference signals from TPs and measures DL RSTD and/or RSRP. Examples of DL positioning methods are DL-AoD or DL-TDOA positioning. A “UL positioning method” may refer to any positioning method that uses uplink reference signals such as SRS for positioning. The WTRU transmits SRS to multiple RPs and the RPs measure the UL Relative Time of Arrival (RToA) and/or RSRP. Examples of UL positioning methods are UL-TDOA or UL-AoA positioning. A “DL and UL positioning method” may refer to any positioning method that uses both uplink and downlink reference signals for positioning. In one example, a WTRU transmits SRS to multiple TRPs and gNB measures reception-transmission time difference, which is calculated based on the time of arrival of DL RS (e.g., PRS). The gNB can measure RSRP for the received SRS. The WTRU measures reception-transmission time difference for PRS transmitted from multiple TRPs. The WTRU can measure RSRP for the received PRS. The reception-transmission difference and possibly RSRP measured at WTRU and gNB are used to compute round trip time. Here “WTRU reception-transmission time difference” refers to the difference between arrival time of the reference signal transmitted by the TRP and transmission time of the reference signal transmitted from the WTRU. An example of DL and UL positioning method is multi-RTT positioning.

For example, details related to CIR and its association to RS configurations are provided. An example of measurement may be a CIR. A CIR, consisting of N paths, may be defined by the following equation

$$h ( t ) = {\sum }_{k = 1}^{N} {h}_{k} ( t ) δ ( t - {τ}_{k} )$$

where hₖ(t) and τₖ are time-varying complex valued coefficients (e.g., expressed by a+bj where j=\sqrt{−1} for the CIR and delay, measured in seconds, for the k^{th} path, respectively). The delta function is defined as δ(t)=1 for t=0 and δ(t)=0 for t≠0.

For example, it is assumed the coefficients are constant over time, e.g., hₖ(t)=hₖ. The WTRU may report hₖ and τₖ for each path k to the network. The WTRU may report the number of paths, N, to the network. Alternatively, the WTRU may receive hₖ and τₖ for each path k from the network and/or the number of paths.

In another example, the WTRU may obtain CIR from the network. The network may indicate one or more DL-RS configurations such as DL-RS resource IDs associated with the CIR.

For example, the CIR may be associated with DL-RS resource ID. In this case, the WTRU may determine that the CIR is derived based on the measurements made on the DL-RS resource associated with the ID. Alternatively, the WTRU may determine that the channel along the direction of transmission of the DL-RS or reception of the DL-RS corresponds to the CIR.

In another example, the CIR may be associated with a TRP ID. In this case, the WTRU may determine that the CIR represents the channel between the associated TRP and WTRU. In another example, the CIR may be associated with two or more TRPs where the network may include TRP indices associated with the CIR.

In another example, the CIR may be associated with a cell. In this case, the WTRU may receive cell ID or index associated with the CIR from the network.

In another example, CIR may be associated with two or more TRPs or DL-RS resource IDs. In this case, the WTRU may determine that the channel between the TRPs and the WTRU corresponds to the CIR. Alternatively, the WTRU may determine that the channel along the transmission directions of DL-RSs associated with IDs or reception directions of the DL-RS correspond to the CIR.

In another example, two or more CIRs may be associated with one parameter from DL-RS configurations (e.g., TRP ID, DL-RS resource ID, frequency layer ID, or the like). For example, the WTRU may receive information related to two CIRs associated with a TRP from the network, e.g.,

$${h}_{1} ( t ) = {\sum }_{k = 1}^{{N}_{1}} {h}_{1 , k} ( t ) δ ( t - {τ}_{1 , k} ) and {h}_{2} ( t ) = {\sum }_{k = 1}^{{N}_{2}} {h}_{2 , k} ( t ) δ ( t - {τ}_{2 , k} )$$

from the network. Alternatively, the WTRU may report information related to two or more CIRs associated with DL-RS configuration (e.g., TRP ID, DL-RS resource ID, or the like) based on the measurements to the network. There can be two or more CIRs associated with DL-RS configuration since the WTRU or network may observe different channel characteristics based on AoA of DL RS or UL RS, for example.

For example, CIR may be represented by delay profile (DP) or power delay profile (PDP). A power delay profile may be defined as a set of delays and power profiles, such as [τ₀, τ₁, . . . , τ_{N-1}] and [p₀, p₁, . . . , p_{N-1}], where pₖ may correspond to relative power at the k^{th} path compared to the first path. A delay profile may be defined as a set of delays [τ₀, τ₁, . . . , τ_{N-1}] which indicates path delay for each path above p_{threshold}. The WTRU may receive p_{threshold} from the network to derive delay profile from power delay profile.

In another example, the CIR the WTRU reports to the network may be defined by a configured number of samples (e.g., N) where the WTRU is configured with a granularity of samples (e.g., X seconds apart). The number of samples may be defined within a window. The WTRU may report samples whose RSRP is over the configured threshold or an M highest RSRP among the samples. The WTRU may indicate locations or a sample index of samples where the WTRU measures an M highest RSRP among the samples. The first sample may be defined as the earliest arriving path, e.g., first path. In another example, the samples may be defined with respect to the reference timing (e.g., ToA of reference or indicated DL-RS, ToA of the earliest arriving DL-RS, or the like). The WTRU may report timing, phase and/or power information per sample. The determined reference timing or first path may be rounded up or down to the defined timing granularity. The CIR, PDP and/or DP may be defined as the impulse response between WTRU and TRP or associated with a DL-RS (e.g., DL-RS resource ID) or DL-RS resources (e.g., DL-RS resource IDs).

In one example, the WTRU may receive an indication from the network on how to generate CIR, PDP and/or DP based on timing, phase and/or power measurements. In one example, the WTRU may send a request to the network to receive an indication on which methodologies to use to generate CIR, PDP and/or DP based on the measurements the WTRU made. For example, the WTRU may receive a message from the network (e.g., via LPP, RRC, MAC-CE, DCI, or the like) indicating the DL-RS resource indices and one or more associated measurement types (e.g., RSTD, AOA, or the like) to use to generate CIR, PDP and/or DP. In one example, the WTRU may receive an indication from the network indicating to generate CIR, PDP and/or DP.

In one example, the WTRU may receive a threshold (e.g., power threshold) from the network and timing range (e.g., 0 μs to 1 μs), timing granularity (e.g., every 0.1 μs in the indicated timing range, 100 sample points in the indicated timing range, or the like) of CIR, PDP and/or DP. In this case, the WTRU may determine to report power and timing (e.g., relative timing compared to a reference timing, absolute timing, or the like) of any samples whose received power is over the threshold.

The WTRU may send measurements in a report to the network (e.g., LMF, gNB, or the like) via a semi-static (e.g., LPP, RRC, or the like) or dynamic message (e.g., UCI, UL MAC-CE, or the like).

In the examples herein, DL-RS (e.g., CSI-RS, DM-RS, TRS, or the like) and SSB may be used interchangeably.

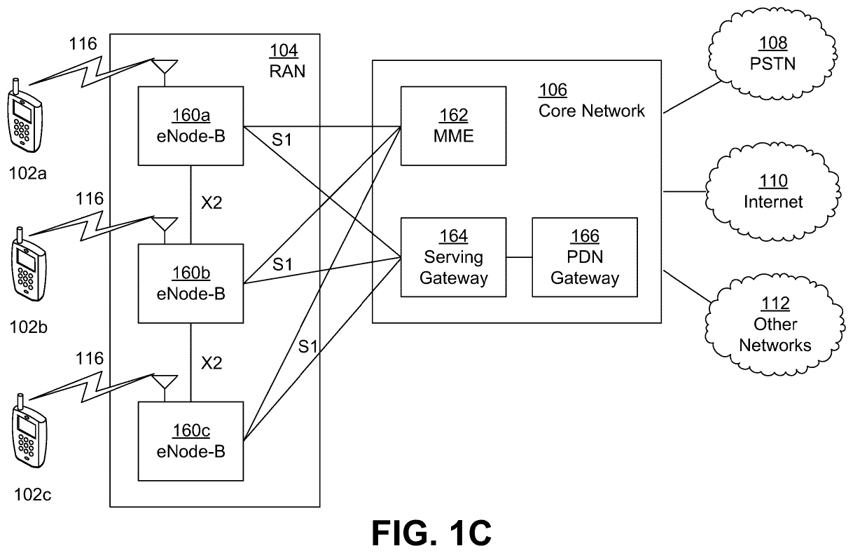

In certain representative embodiments, a wireless network (e.g., LMF, gNB, or the like) performs gNB-based monostatic sensing or bistatic sensing. Examples of monostatic sensing and bistatic sensing are shown in FIGS. 3A and 3B, respectively, where one or more TRPs are attempting to detect a target (e.g., automobile). For example, as shown in FIG. 3A, a system 300 includes a TRP 305, which transmits a DL-RS 310, which may be received (and may be measured) by a WTRU 320. Also, for example, a target 315 is sensed by the TRP 305 via monostatic sensing. Further, for example, as shown in FIG. 3B, a system 350 includes a transmitting (Tx) TRP 355, which transmits a DL-RS 360, which may be received (and may be measured) by a WTRU 370.

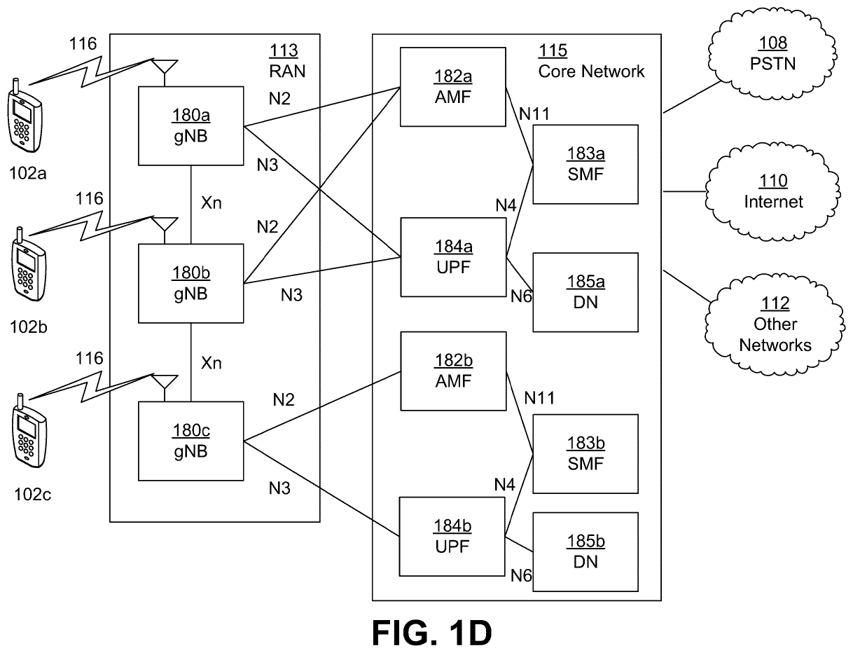

In addition, for example, a target 365 is sensed by the Tx TRP 355 and a receiving (Rx) TRP 380 via bistatic sensing. Moreover, for example, as shown in FIG. 4, a system 400 includes a Tx gNB 410, which transmits a Tx beam for sensing 420, which may be received (and may be measured) by a WTRU 430 and/or a WTRU 440. Furthermore, for example, a target 450 is sensed by the Tx TRP 410 and an Rx TRP 460 via bistatic sensing.

For example, gNB-based sensing can happen without notice, causing sudden interference to the WTRUs. Also, for example, the WTRU is configured to detect gNB-sensing to avoid interference in both DL and UL.

In certain representative embodiments, a WTRU receives configurations for time-frequency resources where sensing signals are transmitted. For example, the WTRU receives a request to make measurements on sensing signals. Also, for example, if the WTRU detects the presence of the sensing signals, the WTRU reports measurements to the network.

For example, the WTRU is configured to perform one or more actions and/or steps. Also, for example, the WTRU is configured to perform at least one of receiving one or more configurations, searching for a sensing signal, monitoring (e.g., at a periodicity), transmit one or more UL signals and/or channels, combinations of the same, or the like. Further, for example, the WTRU receives one or more configurations for one or more signals dedicated for gNB monostatic and/or bistatic sensing. In addition, for example, the one or more configurations indicate a unique sequence for the signals dedicated to the gNB-based sensing. Moreover, for example, the one or more configurations indicate one or more time-frequency resources (e.g., where gNB-sensing signals may be present). Furthermore, for example, the WTRU is configured to search for the sensing signal at a configured search periodicity and/or in one or more designated time-frequency resources. Additionally, for example, the search periodicity and/or the one or more time and frequency resources for searching are related to one or more areas and/or zones in which the WTRU is located. Still further, for example, when the WTRU detects the signal, the WTRU determines monitoring periodicity to search for the signal. Even further, for example, the monitoring periodicity is associated with the time and frequency resource of the signal. Yet further, for example, if the WTRU is configured to transmit uplink signals and/or channels, the WTRU postpones transmission until the WTRU does not find any sensing signal.

In certain representative embodiments, a WTRU receives configurations for time-frequency resource where sensing signals are transmitted. For example, the WTRU receives a request to make measurements on sensing signals. Also, for example, if the WTRU detects the presence of the sensing signals, the WTRU reports measurements to the network. Further, for example, as detailed herein, methods and systems are provided for performing at least one of a configuration of DL-RS (e.g., for gNB-based sensing), searching behavior (e.g., for a sensing RS), post-detection behavior, reporting behavior, WTRU behavior (e.g., after gNB sensing), combinations of the same, or the like.

For example, one or more configurations of DL-RS for gNB-based sensing are provided. In one example, the WTRU may receive, from the network (e.g., gNB, LMF, or the like), one or more configurations related to sensing reference signals (RS) used for network-based sensing (e.g., gNB-based sensing). Also, for example, the network may use sensing RS for NW-based monostatic sensing or bistatic sensing. Examples of the configurations include a configuration for DL-RS or UL-RS (e.g., sequence ID, number of symbols, spatial relationship, QCL, or the like).

For example, time-frequency resources used for NW-based sensing are provided. In one example, the WTRU may receive configurations for time and frequency resources for RS used for gNB-based sensing. Also, for example, as detailed herein, the WTRU may determine the configuration based on at least one of a location of the WTRU, one or more signals transmitted from a network, broadcasted information, capability-based information, combinations of the same, or the like.

For example, regarding a location of the WTRU, the WTRU may determine its location based on a positioning method (e.g., GNSS, RAT dependent positioning method, or the like). The WTRU may be configured with time-frequency resources associated with one or more zones (e.g., defined by one or more zone IDs) and/or areas (e.g., defined by one or more cell IDs), where a zone may be defined by one or more location coordinates. The WTRU may determine, based on the location, time-frequency resources used by the network to transmit DL-RS. In another example, the location may be associated with the sensing RS configurations. The WTRU may determine its location and sensing RS configurations such as periodicity, number of symbols, spatial relationship used for the RS, or the like.

For example, regarding the signals transmitted from the network, the WTRU may determine implicitly the time-frequency resources used for sensing RS based on signals transmitted from the network. Further, for example, the WTRU may be configured with an SSB at indicated time-frequency resources and/or sequences (e.g., sequence ID used to generate the SSB). Each time-frequency resource and/or sequence of SSB may be associated with the time-frequency resource used by the sensing RS. If, for example, the WTRU determines the presence of the SSB (e.g., the RSRP of the SSB is above the configured threshold), the WTRU may determine that sensing RS is being transmitted at the associated time-frequency resource. In another example, upon detection of the SSB, the WTRU may determine associated configurations for sensing RS (e.g., periodicity, spatial relationship, number of symbols, or the like).

For example, regarding the broadcasted information, the WTRU may determine time-frequency resources of the sensing RS based on the broadcasted information sent by the network (e.g., a System Information Block (SIB)).

For example, regarding the capability-based information, the WTRU may determine to perform and/or support implicit sensing operation based on a WTRU's capability (e.g., a supporting capability of implicit sensing). Also, for example, the WTRU may report capability information via RRC message and/or NAS signaling to a network. Also, for example, the capability information may indicate at least support for the implicit sensing operation, which may be with monostatic sensing and/or bistatic sensing.

For example, the WTRU may receive indication to adjust the WTRU transmission behaviors such as modifying or suspending of uplink transmissions on specific resource blocks, during specific time slots, or with respect to certain spatial directions. The WTRU may receive indication to adjust the WTRU reception behaviors such as monitoring of DL reference signals, or a subset thereof, in specific time, frequency, and/or spatial domains.

For example, the WTRU may receive one or more indications regarding one or more gNB-sensing operations implicitly, e.g., by associating one or more preconfigured WTRU behaviors with one or more certain downlink settings. Also, for example, the implicit indications can be done as part of an initial configuration of a WTRU (e.g., RRC). In one solution, the WTRU may receive an implicit indication based on a specific sequence of DL reference signals. In one example, the WTRU may be configured to interpret a specific CSI-RS configuration as an instruction to mute all or a set of UL transmissions for a certain period of time. In another example, the WTRU may be configured to interpret a specific CSI-RS configuration as an instruction to modify DL reception, such as making and reporting measurements. In another approach, the WTRU may deduce implicitly, e.g., upon receiving downlink reference signals with certain periodicity, that gNB-sensing is active. Another implicit signaling solution to the WTRU is to use certain thresholds with respect to the received power of the downlink reference signals.

For example, searching behavior for sensing RS is provided. Also, for example, the searching behavior for sensing RS includes at least one of trigger conditions (e.g., to start searching), a gNB sensing detection mechanism, trigger conditions to stop searching, combinations of the same, or the like.

For example, trigger conditions to start searching are provided. In one example, the WTRU may determine to initiate search for the sensing RS based on at least one of an indication from the network, a message from the network, a measurement on an indicated signal, combinations of the same, or the like.

For example, regarding the indication from the network, the WTRU may determine, e.g., from broadcasted information (e.g., via SIB), that the gNB-based sensing is activated and/or ongoing. The WTRU may determine to receive sensing RS from the configured or determined time-frequency resources. The WTRU may receive the sensing RS at configured or determined periodicity.

For example, regarding the WTRU receiving a message from the network, the message from the network includes, e.g., SBI, RRC message, or the like. The message may indicate to the WTRU a start of a search for the DL-RS signals.

For example, regarding the WTRU making measurements on indicated signals, the signals may be an SSB and/or DL-RS from the network. The WTRU may make measurements on the power characteristics (e.g., full panel power or half panel power, or the like). The WTRU may be configured with an association between a power characteristic and a specific measurement and/or configuration (e.g., periodicity of measurement, time-frequency resources to monitor, or the like).

In one example, the WTRU may determine to search for the sensing RS based on a configured periodicity (e.g., monitoring periodicity). The WTRU may determine the monitoring configurations (e.g., periodicity, sequence ID used for gNB sensing signal, or the like) based on time-frequency resources where the gNB sensing signals may be transmitted. The WTRU may receive, from the network, association between time-frequency resources and monitoring configuration and/or gNB sensing signal configuration.

In one example, the WTRU may determine from the message received from the gNB (e.g., SIB) that gNB-based sensing may start at the indicated timing (e.g., N slots from the timing the WTRU received the message, absolute time, relative time with respect to the reference time, or the like).

In one example, the WTRU may receive a message from the network where the message includes configurations of a time window. The WTRU may search for the sensing RS during the time window.

In one example, once the WTRU determines to initiate search for the sensing RS, the WTRU may determine to start a timer.

For example, a gNB sensing detection mechanism is provided. In one example, the WTRU may determine the presence of the sensing RS at one or more configured or determined time-frequency resources. Also, for example, the determining of the presence of the sensing RS may be based on at least one a power measurement, an RSRP measurement, a number of RSRP measurements, a presence of an indication signal, a parameter of the indication signal, a timing of the measurements relative to the indication signal, combinations of the same, or the like.

For example, the WTRU may determine the presence of the sensing RS when a power measurement (e.g., RSRP) measured at the time-frequency resources is above a configured threshold.

For example, the WTRU may determine the presence of the sensing RS when an RSRP measured during a configured time window or duration is above the configured threshold where the RSRP may be processed (e.g., averaged) by the WTRU.

For example, the WTRU may determine the presence of the sensing RS when an RSRP measured periodically during a configured time window is above the configured threshold where the RSRP may be processed (e.g., averaged) by the WTRU.

For example, the WTRU may determine the presence of the sensing RS when an RSRP measured at a configured number of occasions is above the configured threshold, where the measured RSRP may be processed (e.g., averaged).

For example, the WTRU may determine the presence of the sensing RS when a number of occasions where the measured RSRP over the configured threshold is above a configured number.

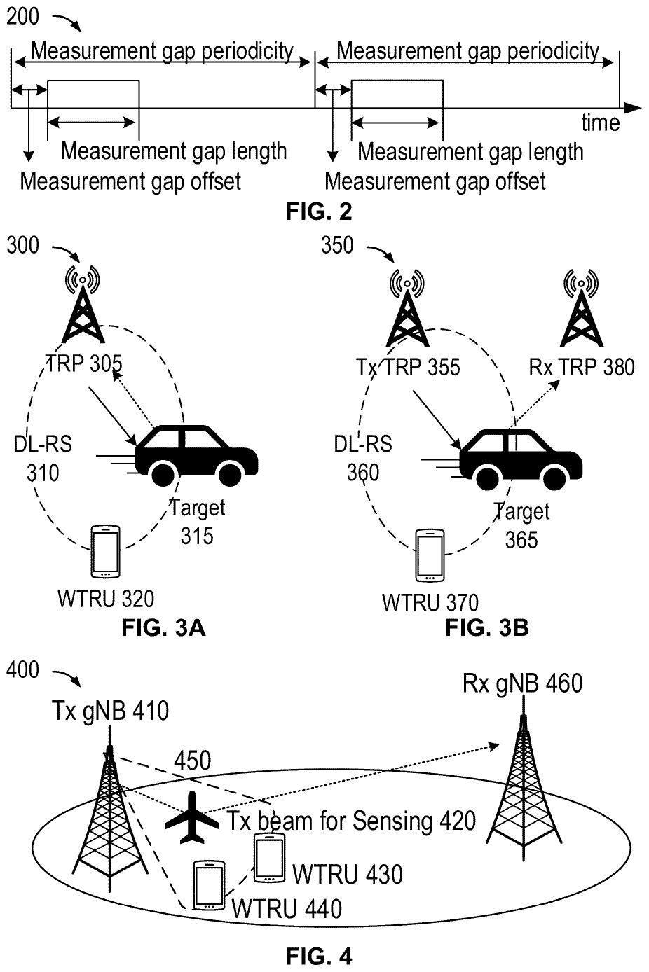

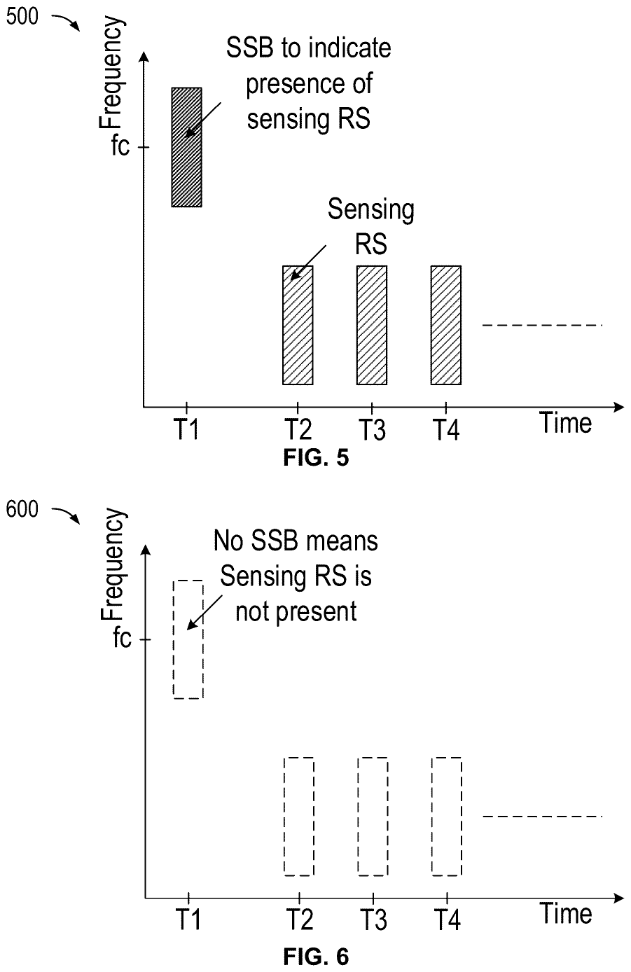

For example, the WTRU may determine the presence of the sensing RS in the presence of an indication signal (e.g., SSB). In one example, the WTRU may be configured with an indication signal (e.g., indication SSB) which indicates the presence of sensing RS. In one example, the WTRU may determine that if the indication SSB is present (e.g., measured RSRP for the indicated SSB is above the configured threshold), the WTRU may determine that the sensing DL-RS is present and gNB-based sensing is ongoing. In another example, if the WTRU determines that the indicated SSB is not present (e.g., measured RSRP for the indicated SSB is less than the configured threshold), the WTRU may determine that the sensing DL-RS is not present and gNB sensing is not ongoing. Examples are illustrated in FIGS. 5 and 6.

In FIG. 5, a chart 500 plots a frequency of a sensing RS on the y-axis versus time on the x-axis. SSB is located at center frequency fc. The WTRU detects SSB at time t=T1. Once the WTRU discovers the SSB, the WTRU determines that the associated sensing RS is located at configured timings. In this example, the sensing RS may be transmitted periodically, e.g., T3=T2+T, T4=T3+T, where T is the periodicity. The WTRU may be configured with a timing offset between SSB and sensing RS, e.g., Td=T2−T1, where Td denotes the timing offset. The sensing RS at T2 may be the first sensing RS after the SSB, which indicates the presence of sensing RS. The SSB, which indicates the presence of the sensing RS, may be transmitted periodically. This means that the sensing RS is also transmitted periodically. The sensing RS may be transmitted with a time offset after a periodically transmitted SSB.

In FIG. 6, a chart 600 plots a frequency of a sensing RS (or lack thereof) on the y-axis versus time on the x-axis. An example is illustrated where the WTRU does not detect the SSB, which indicates the presence of sensing RS. The WTRU may not detect the SSB since the measured RSRP is below the configured threshold. The WTRU may determine that since the SSB is not present, the corresponding sensing RS is not present at t=T2, t=T3 and t=T4. In one example, the WTRU may determine the presence of sensing RS by discovering the indication signal. The WTRU may determine to make measurements on the sensing RS if the WTRU is configured to make measurements on the sensing RS for reporting the measurements to the network.

In one example, the WTRU may determine configurations (e.g., one or more configuration parameters) of the sensing RS based on the parameter of the indication signal. For example, a configuration parameter for the indication signal (e.g., periodicity, sequence, transmission power, number of symbols, or the like) may be associated with a configuration parameter of the sensing RS (e.g., bandwidth, location in the time-frequency resources, center frequency, or the like). The WTRU may be configured with a table associating a configuration parameter of the sensing RS (e.g., periodicity, location of in the time-frequency resource, or the like) and a configuration parameter for the indication signal. In another example, the WTRU may be configured with signals for a communication purpose (e.g., SSB). While gNB sensing is active, the parameters for the signals (e.g., sequence used for SSB) may be changed by the network to the parameter to indicate the presence of gNB sensing signals. Also, for example, the first sequence may be used for the SSB during communication. During gNB sensing, the second sequence may be used for the SSB. The WTRU may receive the SSB and determine whether the first or second sequence is used and detect whether gNB-based sensing is activated or deactivated.

In one example, the WTRU may determine to make measurements on the sensing RS after discovery of the indication signal if the WTRU is configured with time-frequency resources (e.g., range) for the sensing RS. In one example, the indication SSB may indicate a range of time-frequency resources (e.g., from frequency F1 to F2 and time range of t=Ts to t=Te). The frequency range may be expressed by at least one or a combination of the following: frequency (e.g., Hz), frequency layer ID, carrier component ID, resource block number or index or resource element ID or index, or the like. The WTRU may be configured with bandwidth or duration (e.g., a number of OFDM symbols) for the sensing RS. Based on the configuration, the WTRU may perform a blind search for the sensing RS in the configured range. In one example, the parameters of the indication signal (e.g., SSB) may be associated with monitoring periodicity for the indication signal or sensing RS. For example, the WTRU may receive, from the network, a table associating a parameter of the indication signal (e.g., sequence) and monitoring periodicity of sensing RS (e.g., every 10 ms). In another example, the WTRU may determine a time offset between the indication signal and sensing RS such that the WTRU can determine when to start monitoring the sensing RS. The WTRU may determine the time offset based on configuration or association rule(s) between the parameter of the indication signal and time offset. For example, in FIG. 5, the time offset between the indication signal and the first sensing RS symbol is T2−T1.

In one example, the WTRU may determine RSRP. For example, the WTRU may determine RSRP is based on at least one of: using a configured or determined sequence for the DL-RS (e.g., via a correlation operation); using a method that does not require the knowledge (e.g., sequence) of the DL-RS, e.g., envelope detection; combinations of the same; or the like.

In the embodiments described herein, “detection” and “discovery” may be used interchangeably. Similarly, “detect” and “discover” may be used interchangeably.

In one example, the WTRU may determine to monitor indication signals from gNBs outside of the serving cell. The WTRU may receive time-frequency resources used to transmit the indication signals via broadcast from neighboring cells. The WTRU may report, e.g., to the one or more gNBs in the serving cell, that the reported measurements made on the signals (e.g., SSB, DL RS, or the like) or channels transmitted by the serving gNBs or cells are made while neighboring cells are transmitting sensing RS for gNB-based sensing. Such an indication may be useful for the gNB in the serving cells to understand whether there was a potential interference during the measurement.

The WTRU may, for example, be configured with first and second reference signals within a TCI state, e.g., where first and second reference signals are applicable when gNB sensing signal is not present and present, respectively. The first and second reference signals may be configured as QCL sources of type A, B, C or D within the TCI state. For example, first and second reference signals may consist of CSI-RS for tracking or SSBs. The WTRU may monitor first and second reference signals for the indicated TCI state and determine that a sensing reference signal is transmitted or will be transmitted based on whether a first or a second reference signal is detected and/or whether the first reference signal is detected with CSI-RSRP or SS-RSRP larger than that of the second reference signal. For the purpose of beam detection and/or radio link monitoring, the WTRU may use the strongest between the first and second reference signals as a detection resource.

The WTRU may be configured for detection of a low-power wake-up signal (LP-WUS) according to first and second configurations. The WTRU may determine that a gNB sensing signal is present or not present based on whether LP-WUS of the first or second configuration is detected, respectively.

The WTRU may be configured with first and second sets of coresets and/or search spaces for Physical Downlink Control Channel (PDCCH) reception. The WTRU may monitor PDCCH on both the first and second sets. The WTRU may determine that gNB sensing signal is present or not present based on if it receives PDCCH on a coreset or on a search space that is part of the first or second set, respectively.

For example, trigger conditions to stop searching are provided. In one example, the WTRU may determine to stop searching for the sensing RS. Also, for example, the WTRU may determine to stop searching for the sensing RS based on at least one of the following: an RSRP measured at the time-frequency resources is below the configured threshold; an RSRP measured during a configured time window or duration is below the configured threshold where the RSRP may be processed (e.g., averaged) by the WTRU; an RSRP measured periodically during a configured time window is below the configured threshold where the RSRP may be processed (e.g., averaged) by the WTRU; an RSRP measured at a configured number of occasions is below the configured threshold, where the measured RSRP may be processed (e.g., averaged); a number of occasions where the measured RSRP below the configured threshold is above the configured number; a time elapsed since the indication, sent from the network, of the sensing operation is over the configured time threshold (e.g., number of frames, number of subframes, number of slots, number of symbols, seconds, or the like); an indication from the network (e.g., SIB, RRC message, LPP message, DCI, MAC-CE, or the like) that the gNB-based sensing has stopped; combinations of the same; or the like.

In one example, once the WTRU determines to stop searching for the sensing RS, the WTRU may determine to stop the timer and reset the value of the timer.

For example, post detection behavior is provided. Also, for example, the post detection behavior includes at least one of one or more overriding configurations, a measurement gap, cancellation behavior, combinations of the same, or the like.

For example, overriding configurations are provided. In one example, the WTRU may determine to change configurations based on the discovery of the gNB-based sensing signals. Also, for example, the WTRU may be configured with one or more Time Division Multiplexing (TDD) configurations indicating frames or slots as downlink, uplink or special slots (e.g., mix of downlink or uplink symbols and/or blank slots or symbols, or the like). If the duration of gNB-sensing overlaps with the configured downlink, uplink or special slots, the WTRU may determine to covert the overlapped slots or symbols into blank slots or symbols, implying that the WTRU does not take any action (e.g., no transmission of uplink channels or signals, no reception of downlink channels or signals, or the like).

In one example, for the time resources (e.g., slots, frames, symbols, or the like) that do not overlap the gNB-based sensing duration, the WTRU may determine to keep the format of the time resources as configured (e.g., uplink symbols, downlink symbols, special symbols, or the like).

For example, a measurement gap is provided. Also, for example, during the gNB-based sensing, the WTRU may determine that the network cannot receive signals or channels transmitted by the WTRU. In one example, the WTRU may be configured with one or more measurement gap configurations. Also, for example, each measurement gap configuration may consist of periodicity and duration. Based on the determined periodicity and duration of sensing RS, the WTRU may determine the measurement gap configuration where the WTRU may not transmit UL signals or channels or make measurements during the gap duration.

In another example, the WTRU may be configured with time windows with associated priority. Based on the determined periodicity and duration of sensing RS, the WTRU may determine the time window configuration (e.g., duration, periodicity, or the like). The WTRU may determine to receive DL signals or channels or transmit UL signals (e.g., UL-RS, a scheduling request, or the like) or channels according to the priority level associated with the window. For example, if gNB sensing signals are associated with a higher priority than the DL signals or UL signals the WTRU is scheduled to receive or transmit, respectively, the WTRU may determine to cancel reception or transmission of scheduled DL signals or UL signals during the window, respectively. In another example, if gNB sensing signals are associated with lower priority than the DL signals or UL signals the WTRU is scheduled to receive or transmit, respectively, the WTRU may determine to receive or transmit scheduled DL signals or UL signals during the window, respectively.

For example, cancellation behavior is provided. Also, for example, prior to the gNB-based sensing operation, the WTRU may be configured with TDD configurations, grants (e.g., configured grants, dynamic grants, or the like), or transmissions (e.g., periodic, semi-persistent, aperiodic UL-RS transmission, or the like). The WTRU may determine to transmit UL channels (e.g., PUCCH, PUSCH, or the like) or UL-RS. Also, for example, the WTRU may determine to transmit UL channels based on at least one: a cancellation of all scheduled or configured uplink channel or signal transmission if the uplink resources collide with gNB-based sensing resources (e.g., time and frequency resources, or the like); a cancellation of all scheduled or configured uplink channel or signal transmissions that collide with gNB-based sensing resources. Further, for example, scheduled or configured uplink channel or signal transmissions can be transmitted if they do not collide with the gNB-based sensing resources.

In another example, the WTRU may postpone transmission of scheduled channels or signals until the gNB-based sensing is deactivated.

For example, reporting behavior is provided. In one example, the WTRU may receive (e.g., via broadcast, unicast, or the like) an indication from the network initiating gNB monostatic and/or bistatic sensing. The indication may be an indication to initiate transmission and/or reception of the sensing signal, an indication to activate gNB sensing time window, or the like.

In one example, the WTRU may receive a configuration to perform and report measurements on the gNB sensing signal. In one example, the indication from the network may be an indication to activate a (e.g., preconfigured or configured) measurement window for the WTRU to perform measurements.

In one example, the WTRU may be configured with the gNB reference signal configurations (e.g., sequence of the reference signal, time-frequency resources, or the like). In such cases, the WTRU may be configured to perform at least one of the measurements on the reference signal including at least one of: power measurement, DL-RSRP, DL-RSRPP, angle-of-arrival (AoA), time-of-arrival (ToA), or the like.

In one solution, the WTRU may determine to report the measurement to the network. For example, the WTRU may determine to report the measurement to the network based on at least one of the following conditions: at least one of the measurements (e.g., power measurement, DL-RSRP, DL-RSRPP, or the like) is above or below a preconfigured or configured threshold; a difference between at least one of the measurements is above or below a preconfigured or configured threshold; at least one statistic (e.g., variance) of measurement is above or below a preconfigured or configured threshold; combinations of the same; or the like.

In another example, the WTRU may be configured to periodically report the downlink measurements.

The WTRU may report at least one of the following to the network: at least one of the measurements (e.g., DL-RSRP, DL-RSRPP, AoA, ToA, or the like); at least one of the one or more DL resource IDs associated with the measurement; WTRU location (e.g., in terms of 2D or 3D location, sector ID, cell ID, or the like); a timestamp of the measurement (e.g., in terms of symbol index, slot index, frame index, sub-frame index, absolute time, or the like); combinations of the same; or the like.

In one example, the WTRU may receive a request to report measurements made at the configured or indicated resources. The WTRU may report the measurements at a periodicity configured by the network. The WTRU may make measurements on signals outside or inside of the active BWP. The WTRU may determine to terminate reporting once the power measurement is below the configured threshold and/or the WTRU receives an indication to stop reporting measurements.

In one solution, a network may configure a configuration for sensing measurement reporting. The configuration may comprise an indication (e.g., enabling and/or disabling, or the like) whether to report or not for the measured sensing measurement results after measuring and/or monitoring one or more DL signals for sensing.

In one example, a network may implicitly configure the enabling or disabling of sensing measurement reporting based on the reception of one or more specific DL signals. For example, the network may configure at least one DL signal associated with sensing monitoring and a threshold for the DL-RSRP value. Upon receiving the associated sensing DL signal with a value above (or below) the configured threshold, a WTRU may enable (or disable) sensing measurement reporting. Based on the measured DL-RSRP value of the received DL signal, the WTRU can determine whether to enable or disable the reporting of sensing measurement results.

In one example, in an explicit manner, the WTRU may receive the indication of enabling and/or disabling via a message (e.g., DCI and/or MAC-CE and/or RRC) from a network. For example, upon receiving the indication, the WTRU may perform the sensing measurement with one or more measured DL sensing signals.

In one example, the WTRU may receive a message, from the network, to report measurements made on the sensing signals. The WTRU may receive configurations for a time window during which the WTRU is requested to make measurements. The WTRU may receive configurations of conditions (e.g., time limit, detection conditions, or the like) to start or stop measurements. The WTRU may receive one or more configurations for measurements. For example, the one or more configurations for measurements may include at least one or a combination of the following: a specific sequence to make measurements, one or more time-frequency resources to make measurements, a method of power measurements (e.g., envelope detection, received power detection, or the like), or the like.

A WTRU may, for example, report sensing measurement results upon receiving at least one DL signal (e.g., with a measured DL-RSRP value) and/or an indication associated with enablement of sensing measurement reporting.

In one solution, a WTRU may send sensing measurement results with a UL transmission via a piggybacking method. For example, the WTRU may send the sensing measurement results with a remaining UL resource (e.g., via Uplink Buffer Status Report (UL BSR) and/or Scheduling Request (SR) and/or UCI and/or UL MAC-CE and/or UL grant and/or UL RRC message, or the like) for a communication purpose (e.g., not sensing measurement results). Also, for example, the WTRU may report sensing measurement results based on the configuration of Radio Resource Management (RRM) measurement (e.g., communication purpose). Further, for example, the WTRU is preconfigured or configured to use as a part of (or a portion of) configuration of RRM measurement (e.g., Layer-1 and/or Layer-3). In one example, a WTRU may report the sensing measurement results in a simplified format (e.g., bitmap and/or codepoint) with UL transmission. In addition, for example, the bitmap may indicate, e.g., obstacle detection and/or no obstacle and/or sensing DL signal being detected or not detected.

In one example, the WTRU may indicate to report the implicit sensing measurement results with a dedicated Random Access Channel (RACH) preamble and/or an additional RACH occasions and/or SR and/or configured grant and/or UCI. For example, the WTRU may send the indication via early indication method for implicit sensing measurement (e.g., MSG1 and/or MSG3). Each of the RACH preamble and/or occasion and/or indication for UL may associate with one or more preconfigured or configured DL signals and/or locations. Also, for example, the RACH preamble is configured and/or dedicated for 2-step (or 4-step) RACH procedure.

In one example, once the WTRU sends a RACH preamble via one of the additional RACH occasions, the network may determine that the WTRU performs sensing measurement in an implicit manner. For example, the WTRU may send the indication via the SR and/or (e.g., a configured and/or dedicated) UCI. Also, for example, the WTRU may send the indication via SDT (e.g., a configured UL grant).

In one example, the WTRU may receive a request to report the measurements to the network. The WTRU may receive configurations for reporting the measurements (e.g., periodic, semi-persistent, aperiodic, or the like). The WTRU may indicate details of measurements. For example, the details of the measurements include at least one of: time-frequency resources (e.g., RB index, component carrier index, frequency layer index, bandwidth, center frequency, ARFCN, duration, start or end time, or the like) the WTRU made measurements on; whether the measurements are processed (e.g., averaged); methods used to make measurements (e.g., envelop detection); combinations of the same; or the like.

A WTRU may not report sensing measurement results upon receiving an indication (e.g., disabling for sensing measurement reporting). For example, a network may configure to disable the sensing measurement reporting with reception of at least one or more specific DL signals having a value below a configured threshold of a DL-RSRP value and/or specific conditions for limitation. Also, for example, the condition may comprise at least one of a value of a timer (e.g., msec, sec, mins, or the like) and/or a time gap and/or a duration, or the like.

In one solution, a WTRU may not report sensing measurement results if a detected and/or measured DL signal for sensing and/or an obstacle is detected. For example, upon reception of the specific DL signal for disabling sensing measurement reporting, the WTRU may wait until reception of DL signal for enabling sensing measurement reporting.

In one example, a WTRU may pause and/or maintain and/or store sensing measurement results until receiving the indication of enabling sensing measurement results. For example, the WTRU may report the sensing measurement results once a timer is expired. Also, for example, the WTRU may report sensing measurement results when the configured time duration and/or time gap has passed.

In one example, a WTRU may report sensing measurement results with a sensing mode and/or operation. For example, the WTRU may include an indication of a performance of a function based on one or more sensing modes (e.g., monostatic and/or bistatic, or both).

In one example, the WTRU may stop reporting if the WTRU reports a configured number of occasions to report. In another example, the WTRU may be configured with a time window during which the WTRU reposts measurements. The WTRU may stop reporting if the WTRU reaches an end of a time window for reporting.

For example, WTRU behavior after gNB sensing is provided. In one solution, a network may configure prioritization for sensing or communication operation (e.g., over other operations) among those performed in a configured search space (e.g., a time-frequency resource).

In one example, the network may configure to activate prioritization with at least one specific and/or common DL signal among a plurality of DL signals. For example, at least one specific signal may be associated with a DL-RSRP value. Upon receiving the associated DL signal (e.g., implicitly) that is measured above the RSRP value, the WTRU may activate the prioritized operation, e.g., sensing or communication. Also, for example, the network may activate the prioritization for sensing or communication operation via a DCI and/or MAC-CE and/or SIB and/or RRC message (e.g., cell specific), or the like. The indication of prioritization may comprise a 1-bit indication (e.g., 1: sensing, 0: communication, or the like). The WTRU may activate the prioritized operation upon receiving indication for prioritized operation. The indication of prioritization may be sent in a piggybacking manner with other DCI indications or RRC messages.

In one example, the configured prioritization may be associated with one or more dedicated time-frequency resources (e.g., a search space) and associated time durations and/or time windows and/or time gaps (e.g., msec, sec, mins, or the like). For example, the operation for prioritization may be associated with a location (e.g., zone and/or absolute and/or relative position, or the like). The WTRU may be configured with prioritization and associated conditions and/or one or more resources from a network.

A WTRU may activated or deactivated to perform prioritization upon receiving an associated DL signal and/or receiving an indication from a network.

For example, regarding the prioritization for sensing or communication, in one solution, a WTRU may determine to search for a sensing signal during a search periodicity upon receiving the associated DL signal (e.g., configured with prioritization for sensing). Also, for example, the one or more configured and/or specified DL signals may be indicated and/or associated with at least one or more DL signals (e.g., SSB index, DL reference, or the like). In one solution, a WTRU may determine to search for a sensing signal during the search periodicity upon receiving an indication of prioritization of a sensing operation. The indication may comprise a DCI and/or MAC-CE and/or SIB and/or RRC message, or the like.

For example, regarding the prioritization for sensing or communication, in one example, a WTRU may (e.g., firstly) measure sensing signals among the configured and/or specified DL signals among the DL signals (e.g., for the purpose of sensing) associated with a sensing operation. Also, for example, a WTRU may search and receive and/or monitor sensing signals (e.g., DL-RS) from one or more neighboring cells. Also, for example, one or more configured and/or specified DL signals may be indicated and/or associated with at least one or more DL signals (e.g., SSB index, DL reference, CSI-RS, PTRS, PRS, TRS, or the like).

For example, regarding the prioritization for sensing or communication, in one example, a WTRU may keep monitoring and/or measuring sensing signals when, at least, the configured condition (e.g., time duration and/or location, or the like) is satisfied. Also, for example, a WTRU may report sensing measurement results while the condition is satisfied. Also, for example, the WTRU may report sensing measurement results during the time window and/or time gap for a sensing operation.

For example, regarding the prioritization for sensing or communication, in one example, upon receiving the indication (e.g., prioritization for communication), a WTRU may determine to search for a communication signal at a configured search periodicity. Also, for example, a WTRU may (e.g., firstly) measure detected sensing signals among the configured and/or specified DL signals among the DL signals (e.g., purpose of communication). Further, for example, a WTRU may search and receive communication signals (e.g., DL-RS) from one or more neighboring cells.

For example, regarding the reporting of deactivation of prioritization, in one solution, a WTRU may report sensing measurement results with an indication for the sensing operation. Also, for example, the WTRU may report to the indication (e.g., deactivation of prioritization) if at least one configured condition (e.g., location and/or time window) is not satisfied (e.g., out-of-location, timer is expired, out of time window, or the like).

For example, regarding the reporting of deactivation of prioritization, in one example, an indication for a sensing operation may comprise deactivation of monitoring of sensing signals and/or continuation of monitoring of sensing signals and/or activation of monitoring communication signals.

For example, conditions for discarding measurements are provided. In one example, the WTRU may receive a message, e.g., from the network, to discard measurements made during an indicated time window. A start and/or end time of the time window may be the past, present or future compared to the time the WTRU receives the message. The network may send such a message to the WTRU since gNB-based sensing was taking place during the indicated time window, potentially causing interference to the WTRU measurements. The WTRU may receive an indication as to which signals' measurements (e.g., SSB measurements, CSI-RS measurements, or the like) indicated by an index or an ID of signals (e.g., CSI-RS resource ID, SSB index, or the like) the WTRU should discard.

In one example, the WTRU may receive a message from the network to discard or omit the measurements (e.g., measurements made during an indicated time window). When the WTRU reports measurements to the network (e.g., power measurements such as RSRP, average RSRP, or timing measurements such as ToA, timing advance, or the like), the WTRU may indicate whether the reported measurements include measurements that were recommended, e.g., by the network, to be discarded. The WTRU may indicate such information so that the network has an indication as to whether the reported measurements (e.g., average measurements) include the measurements that were recommended, e.g., by the network to the WTRU, to discard or omit.

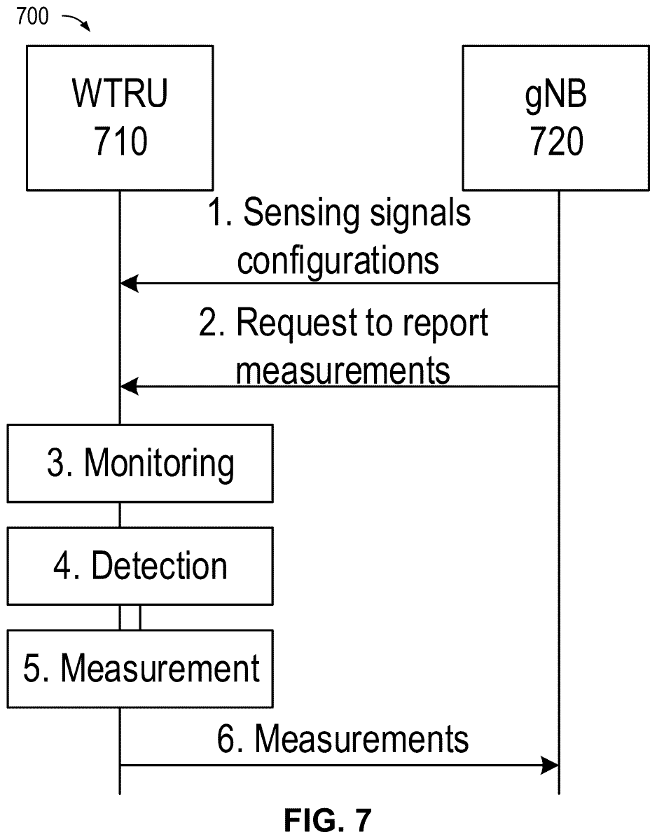

An example of signal exchange between WTRU and gNB is provided. For example, as shown in FIG. 7, a system 700 includes a WTRU 710 and a gNB 720. A method related to the system 700 includes one or more steps. For example, at step 1, the WTRU 710 receives one or more sensing signal configurations from the gNB 720 (see, e.g., one or more configurations of DL-RS for gNB-based sensing). The configuration may contain time-frequency information of signals (e.g., SSB) that indicates the presence of one or more sensing signals (see, e.g., searching behavior for sensing RS). Also, for example, at step 2, the WTRU 710 may receive a request from the network (e.g., via the gNB 720) to report measurements (e.g., RSRP) made on the sensing signal (see, e.g., reporting behavior). Further, for example, at step 3, the WTRU 710 may monitor the signals that indicate the presence of sensing signals (see, e.g., FIG. 5). In addition, for example, at step 4, the WTRU may determine or detect the presence of the sensing signals (see, e.g., FIG. 5). Moreover, for example, at step 5, the WTRU 710 may make measurements on the sensing signal (see, e.g., WTRU behavior, e.g., after gNB sensing). Furthermore, for example, at step 6, the WTRU 710 may determine to report measurements at a configured periodicity (see, e.g., reporting behavior).

In certain representative embodiments, a WTRU determines a duration and timing of gNB-based sensing without excessive signaling from the network. For example, by determining the duration and timing of gNB-based sensing without excessive signaling from the network, reduction of signaling is achieved. Also, for example, as a result of the reduction of signaling, interference between communication and reference signals used for gNB-based sensing is reduced.

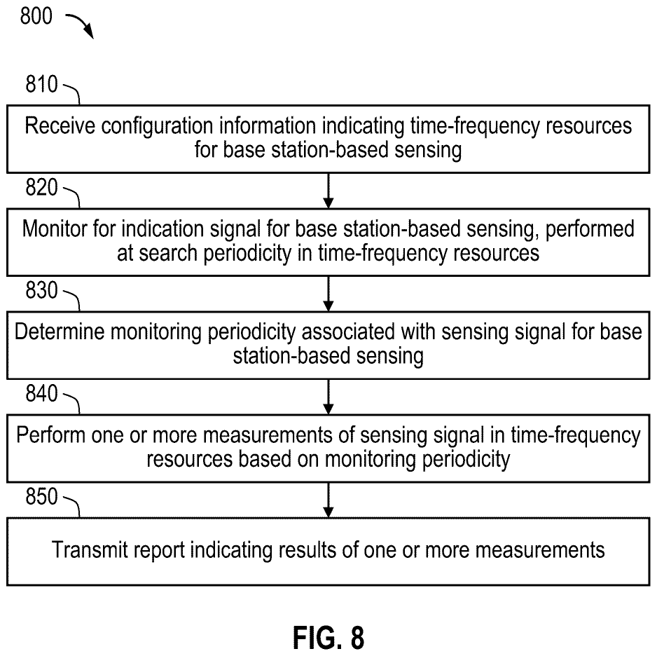

In certain representative embodiments, as shown in FIG. 8, a method 800 is performed by a wireless transmit/receive unit (WTRU) (e.g., WTRU 102, 320, 370, 430, 440, 710, or the like) in communication with a wireless network (e.g., CN 106, 115, TRP 305, Tx TRP 355, Rx TRP 380, Tx gNB 410, Rx gNB 460, gNB 720, or the like). For example, the method 800 comprises at least one of: receiving 810, from the wireless network, configuration information indicating time-frequency resources for base station-based sensing (e.g., step 1, FIG. 7); monitoring 820 for an indication signal for the base station-based sensing (e.g., step 3, FIG. 7), wherein the monitoring is performed at a search periodicity in the time-frequency resources; after detecting the indication signal (e.g., step 4, FIG. 7), determining 830 a monitoring periodicity associated with a sensing signal for the base station-based sensing; performing 840 one or more measurements of the sensing signal in the time-frequency resources based on the monitoring periodicity (e.g., step 5, FIG. 7); or transmitting 850, to the network, a report indicating results of the one or more measurements (e.g., step 6, FIG. 7).

In some embodiments, the method 800 includes one or more additional features as follows. For example, the base station-based sensing comprises monostatic sensing (e.g., FIG. 3A) or bistatic sensing (e.g., FIG. 3B). Also, for example, the configuration information comprises a unique sequence of the time-frequency resources for an expected base station-based sensing signal. Further, for example, the configuration information comprises a sequence of a synchronization signal block (SSB). In addition, for example, the monitoring 820 for the indication signal comprises determining a presence of the SSB (e.g., FIG. 5). Moreover, for example, the search periodicity in the time-frequency resources is related to an area or a zone in which the WTRU is located. Furthermore, for example, the method 800 comprises receiving a message from the wireless network to start monitoring for the indication signal. Additionally, for example, wherein the monitoring 820 for the indication signal is performed in response to receiving the message. Still further, for example, the determining 830 the monitoring periodicity is based on a parameter of the indication signal. Even further, for example, the method 800 comprises canceling or postponing transmission of an uplink signal or channel in an uplink resource that collides with base station-based sensing resources.

In certain representative embodiments, a wireless transmit/receive unit (WTRU) (e.g., WTRU 102, 320, 370, 430, 440, 710, or the like) is provided in communication with a wireless network (e.g., CN 106, 115, TRP 305, Tx TRP 355, Rx TRP 380, Tx gNB 410, Rx gNB 460, gNB 720, or the like). For example, the WTRU comprises a processor (e.g., 118); and a transceiver (e.g., 120) coupled to the processor. Also, for example, the WTRU is configured to perform one or more of the steps of the method 800 described herein.

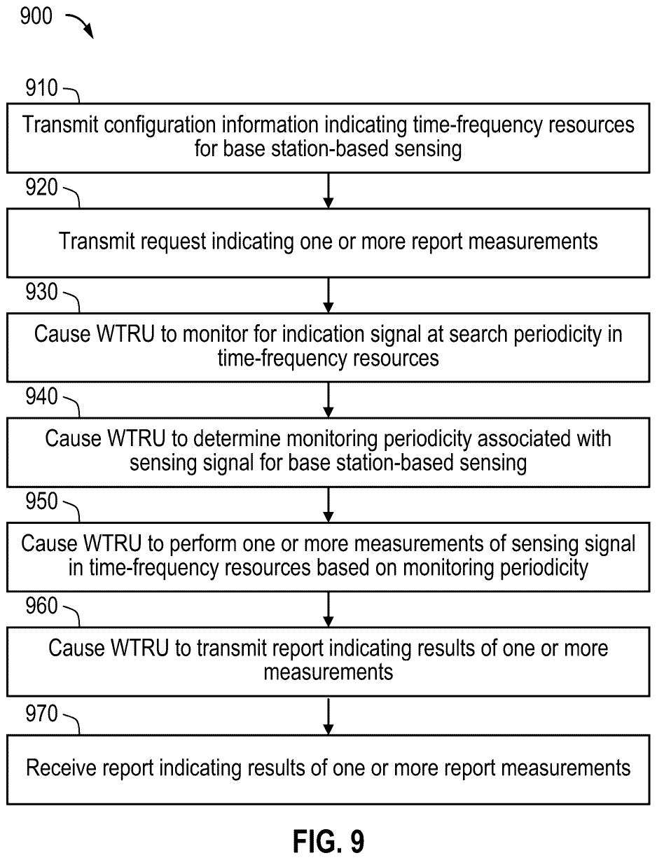

In certain representative embodiments, as shown in FIG. 9, a method 900 is performed by a wireless network (e.g., CN 106, 115, TRP 305, Tx TRP 355, Rx TRP 380, Tx gNB 410, Rx gNB 460, gNB 720, or the like) in communication with a wireless transmit/receive unit (WTRU) (e.g., WTRU 102, 320, 370, 430, 440, 710, or the like). For example, the method 900 comprises at least one of: transmitting 910, to the WTRU, configuration information indicating time-frequency resources for base station-based sensing (e.g., step 1, FIG. 7); transmitting 920, to the WTRU, a request indicating one or more report measurements (e.g., step 2, FIG. 7); causing 930 the WTRU to monitor for an indication signal at a search periodicity in the time-frequency resources (e.g., step 3, FIG. 7); causing 940 the WTRU to, after detecting the indication signal (e.g., step 4, FIG. 7), determine a monitoring periodicity associated with a sensing signal for the base station-based sensing; causing 950 the WTRU to perform one or more measurements of the sensing signal in the time-frequency resources based on the monitoring periodicity (e.g., step 5, FIG. 7); causing 960 the WTRU to transmit, to the network, a report indicating the one or more measurements (e.g., step 6, FIG. 7); or receiving 970, from the WTRU, the report indicating results of the one or more report measurements (e.g., step 6, FIG. 7).

In some embodiments, the method 900 includes one or more additional features as follows. For example, the WTRU is further configured to transmit, to the WTRU, a message to start monitoring for the indication signal. Also, for example, the configuration information comprises a unique sequence of the time-frequency resources for an expected base station-based sensing signal. Further, for example, the search periodicity in the time-frequency resources is related to an area or a zone in which the WTRU is located.

Throughout the specification the phrases “in response to” and “based on” shall be understood to have a broad meaning unless stated otherwise. For example, “in response to” can refer to a step that is in direct or indirect response to a prior step, and “based on” can refer to a step that is based at least in part on a prior step.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery or the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type of medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6, 35 U.S.C. § 112(f) or means-plus-function claim format, and any claim without the terms “means for” is not so intended.

What is claimed:

1. A method performed by a wireless transmit/receive unit (WTRU) in communication with a wireless network, the method comprising:
receiving, from the wireless network, configuration information indicating time-frequency resources for base station-based sensing;
monitoring for an indication signal for the base station-based sensing, wherein the monitoring is performed at a search periodicity in the time-frequency resources;
after detecting the indication signal, determining a monitoring periodicity associated with a sensing signal for the base station-based sensing;
performing one or more measurements of the sensing signal in the time-frequency resources based on the monitoring periodicity; and
transmitting, to the network, a report indicating results of the one or more measurements.

2. The method of claim 1, wherein the base station-based sensing comprises monostatic sensing or bistatic sensing.

3. The method of claim 1, wherein the configuration information comprises a unique sequence of the time-frequency resources for an expected base station-based sensing signal.

4. The method of claim 1, wherein:
the configuration information comprises a sequence of a synchronization signal block (SSB); and
the monitoring for the indication signal comprises determining a presence of the SSB.

5. The method of claim 1, wherein the search periodicity in the time-frequency resources is related to an area or a zone in which the WTRU is located.

6. The method of claim 1, further comprising:
receiving a message from the wireless network to start monitoring for the indication signal,
wherein the monitoring for the indication signal is performed in response to receiving the message.

7. The method of claim 1, wherein the determining the monitoring periodicity is based on a parameter of the indication signal.

8. The method of claim 1, comprising:
canceling or postponing transmission of an uplink signal or channel in an uplink resource that collides with base station-based sensing resources.

9. A wireless transmit/receive unit (WTRU) in communication with a wireless network, the WTRU comprising:
a processor; and
a transceiver coupled to the processor, wherein the WTRU is configured to:
receive, from the wireless network, configuration information indicating time-frequency resources for base station-based sensing;
monitor for an indication signal at a search periodicity in the time-frequency resources;
after detecting the indication signal, determine a monitoring periodicity associated with a sensing signal for the base station-based sensing;
perform one or more measurements of the sensing signal in the time-frequency resources based on the monitoring periodicity; and
transmit, to the network, a report indicating results of the one or more measurements.

10. The WTRU of claim 9, wherein the base station-based sensing comprises monostatic sensing or bistatic sensing.

11. The WTRU of claim 9, wherein the configuration information comprises a unique sequence of the time-frequency resources for an expected base station-based sensing signal.

12. The WTRU of claim 9, wherein:
the configuration information comprises a sequence of a synchronization signal block (SSB); and
monitoring for the indication signal comprises determining a presence of the SSB.

13. The WTRU of claim 9, wherein the search periodicity in the time-frequency resources is related to an area or a zone in which the WTRU is located.

14. The WTRU of claim 9, further comprising:
receiving a message from the wireless network to start monitoring for the indication signal,
wherein the monitoring for the indication signal is performed in response to receiving the message.

15. The WTRU of claim 9, wherein the determining the monitoring periodicity is based on a parameter of the indication signal.

16. The WTRU of claim 9, comprising:
canceling or postponing transmission of an uplink signal or channel in an uplink resource that collides with base station-based sensing resources.

17. A method performed by a wireless network in communication with a wireless transmit/receive unit (WTRU), the method comprising:
transmitting, to the WTRU, configuration information indicating time-frequency resources for base station-based sensing;
transmitting, to the WTRU, a request indicating one or more report measurements;
causing the WTRU to:
monitor for an indication signal at a search periodicity in the time-frequency resources;
after detecting the indication signal, determine a monitoring periodicity associated with a sensing signal for the base station-based sensing;
perform one or more measurements of the sensing signal in the time-frequency resources based on the monitoring periodicity; and
transmit, to the network, a report indicating the one or more measurements; and
receiving, from the WTRU, the report indicating results of the one or more report measurements.

18. The method of claim 17, wherein the WTRU is further configured to transmit, to the WTRU, a message to start monitoring for the indication signal.

19. The method of claim 17, wherein the configuration information comprises a unique sequence of the time-frequency resources for an expected base station-based sensing signal.

20. The method of claim 17, wherein the search periodicity in the time-frequency resources is related to an area or a zone in which the WTRU is located.
